(19) United States
(12) Patent Application Publication
(10) Pub. No.: US 2015/0262768 A1
(43) Pub. Date: Sep. 17, 2015

(54) SWITCHGEAR HAVING VISIBLE BREAK WINDOW

(71) Applicant: Thomas & Betts International, LLC, Wilmington, DE (US)

(72) Inventors: Larry N. Siebens, Asbury, NJ (US); Scott Foerster, Florham Park, NJ (US); Daniel L. Gardner, Collierville, TN (US)

(21) Appl. No.: 14/643,092

(22) Filed: Mar. 10, 2015

Related U.S. Application Data
(60) Provisional application No. 61/950,996, filed on Mar. 11, 2014.

(51) Int. Cl. H01H 9/26; H01H 9/02

(52) U.S. Cl. CPC H01H 9/26; H01H 9/02; H01H 2009/0292

(57) ABSTRACT

A switchgear assembly includes a first body housing a circuit breaker and a first control enclosure connected to the first body. The first control enclosure includes a first operating handle that opens and closes the circuit breaker. The switchgear assembly also includes a second body and a second control enclosure. The second body is coupled to the first body, includes a viewing window and houses a switch. The second control enclosure is connected to the second body and includes a second operating handle. The second operating handle is interlocked with the first operating handle to prevent the switch from being opened when the circuit breaker is closed. The viewing window displays an open connection for the switch when the second operating handle is in the open position and displays a closed connection for the switch when the second operating handle is in the closed position.

### RELATED APPLICATION

This application claims priority under 35 U.S.C. §119 based on U.S. Provisional Patent Application No. 61/950,996 filed Mar. 11, 2014, the disclosure of which is hereby incorporated herein by reference.

Electrical switchgear must be de-energized before maintenance personnel can work on the equipment. De-energizing the switchgear typically involves opening a circuit breaker, either remotely or at the switchgear, to de-energize the equipment. The maintenance personnel may also take electrical measurements to ensure that the circuit(s)/equipment has been properly de-energized before working on the equipment.

### BRIEF DESCRIPTION OF THE DRAWINGS

FIG. 1A is an isometric view of a portion of switchgear consistent with an exemplary embodiment;

FIG. 1B is front view of a portion of the switchgear of FIG. 1A;

FIG. 2 is an isometric view of a switchgear assembly including the switchgear of FIG. 1A consistent with an exemplary embodiment;

FIGS. 3-5 are side views of the switchgear assembly of FIG. 2 in different states of operation;

FIGS. 6A and 6B are front views of a portion of the switchgear of FIG. 1A illustrating the states of the contacts via the viewing windows;

FIG. 7 is a side view of the switchgear assembly of FIG. 1A while in a grounded state of operation;

FIGS. 8A and 8B are front views of a portion of the switchgear of FIG. 1A illustrating the states of the ground contacts via the viewing windows;

FIG. 9A is a cross-sectional view of a switch used in the switchgear of FIG. 1A in accordance with an exemplary implementation;

FIG. 9B is an isometric view of the switch of FIG. 9A;

FIG. 10 is a cross-sectional view of another switch used in the switchgear of FIG. 1A in accordance with another exemplary implementation; and

FIG. 11 is an isometric view of a portion of switchgear consistent with another exemplary embodiment.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Embodiments described herein provide switchgear with viewing windows to aid personnel in determining whether a circuit is energized. For example, in one embodiment, a viewing window is provided in each phase of switchgear to allow personnel to see a break in an electrical circuit when a circuit breaker or switch has been opened. In addition, in some implementations, a second viewing window is provided in each phase of the switchgear to allow personnel to see whether a ground connection has been made. The switchgear may also include interlocks, such as mechanical interlocks, to ensure that the equipment is de-energized and/or grounded in a particular sequence.

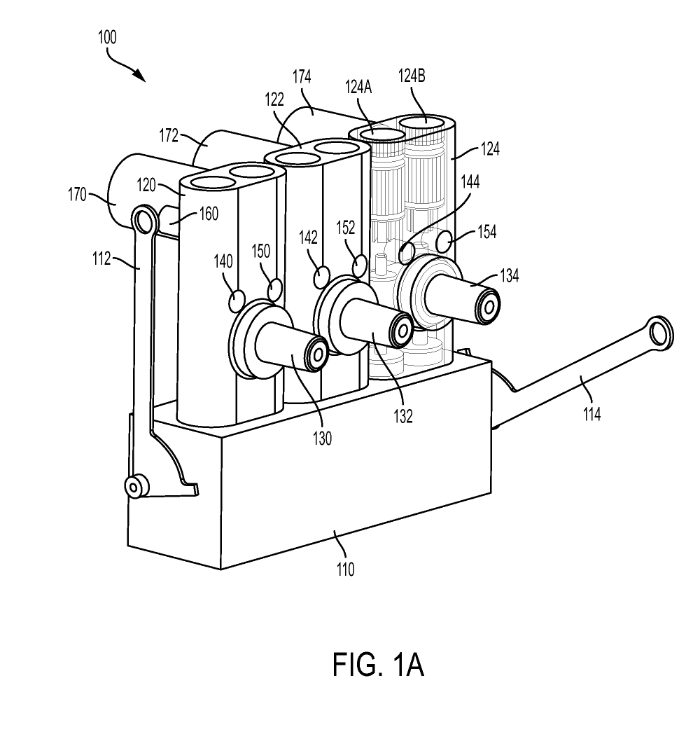

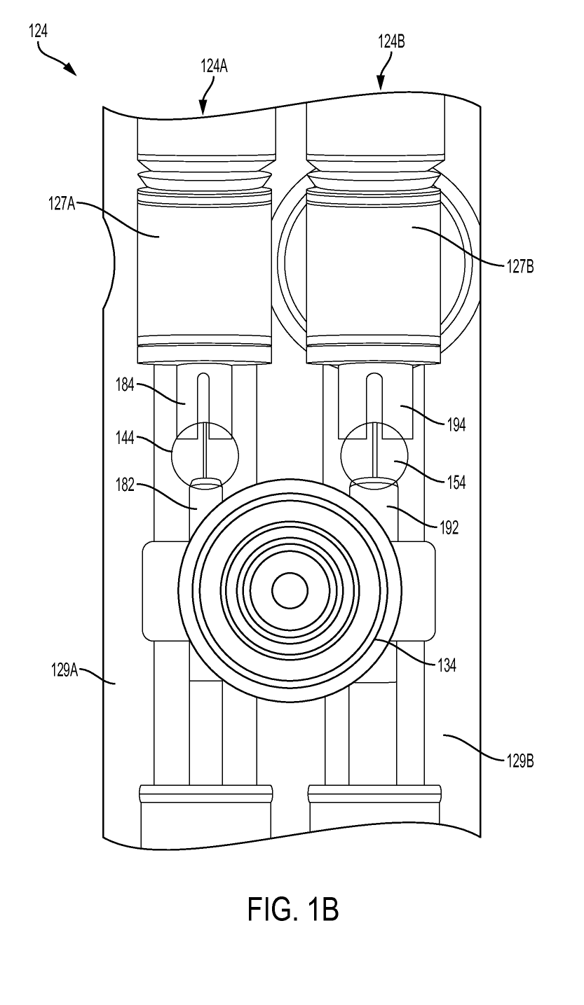

FIG. 1A is an isometric view of a portion of switchgear 100 in accordance with an exemplary embodiment. Referring to FIG. 1A, switchgear 100 includes enclosure or cabinet 110, visible break operating handle 112 (also referred to as visible open operating handle 112), ground operating handle 114, tubes or bodies 120, 122 and 124, interfaces/bushings 130, 132 and 134, viewing windows 140, 142, 144, 150, 152 and 154, ground stud 160 and interfaces/terminals 170, 172 and 174. The exemplary configuration illustrated in FIG. 1A is provided for simplicity. It should be understood that switchgear 100 may include more or fewer devices than illustrated in FIG. 1A. For example, switchgear 100 is illustrated as being 3-phase switchgear. In other implementations, switchgear 100 may be implemented for a single phase installation. In such an implementation, switchgear 100 may include only one of tubes 120, 122 and 124. Switchgear 100 may interface with other switchgear that operates to open and close circuits (e.g., molded vacuum interrupters/switches) associated with providing power to switchgear 100 through connections via terminals 170, 172 and 174, as described in detail below.

Cabinet 110 includes interlocking control mechanisms that prevent operating handles 112 and 114 from being operated (e.g., opened and closed) out of sequence. For example, in one implementation, operating handle 112 may be connected via a mechanical interlock/link that prevents ground operating handle 114 from being closed while visible break operating handle 112 is in the closed position. In addition, the mechanical interlock between visible break operating handle 112 and ground operating handle 114 may prevent visible break operating handle 112 from being closed while ground operating handle 114 is in the closed position.

Each of tubes 120, 122 and 124 may include an outer shell made of an insulating material, such as ethylene propylene diene monomer (EPDM) or some other type of rubber. Each of tubes 120, 122 and 124 is illustrated as containing two individual members/tubes. Each of the individual members/tubes in tubes 120, 122 and 124 is electrically isolated from the other tube and may include a separate circuit breaker or switch to open and close an electrical connection or a ground connection. For example, the left tube of the two tubes included in tube 124 (labeled 124A) may include a ground connection switch used to open/close a ground connection to ground switchgear 100 to, for example, ground stud 160, which may be connected to an external ground. In some implementations, each tube 120, 122 and 124 may include a ground stud connected to an external ground, similar to ground stud 160. The right tube labeled 124B may include a circuit breaker or switch to open/close an electrical connection supplying power to a load via a conductor coupled to bushing 134, as described in detail below.

Each of tubes 120, 122 and 124 also includes two viewing windows. For example, tube 120 includes viewing windows 140 and 150, tube 122 includes viewing windows 142 and 152 and tube 124 includes viewing windows 144 and 154. Each of windows 140-154 may be circular or oval shaped and be made of a transparent plastic, glass or other transparent material that allows personnel to see inside the corresponding tube. In one implementation, viewing windows 140, 142 and 144 are associated with ground contacts and viewing windows 150, 152 and 154 are associated with electrical contacts to a line/load. When visible break operating handle 112 is moved from the closed position illustrated in FIG. 1A to the open position, the electrical circuit breakers/switches in each of tubes 120, 122 and 124 are opened. Personnel may then look into viewing windows 150, 152 and 154 and verify that the electrical connections are open, as described in more detail below. When ground operating handle 114 is moved from the open position illustrated in FIG. 1A to the closed position, the ground switches in each of tubes 120, 122 and 124 are closed. Personnel may then look into viewing windows 140, 142 and 144 and verify that the ground connections are closed, as described in more detail below.

As described above, each of insulating tubes 120, 122 and 124 includes an electrical connection and a ground connection. For example, FIG. 1B illustrates a front view of tube 124. Referring to FIG. 1B, tube 124 includes tube 124A and 124B. Tube 124A includes a ground switch with ground contact/pin 182 and female contact 184. Cylindrical structure 127A may include an outer insulator surrounding a sliding electrical contact that makes contact with contact 182 when the ground switch is closed. Similarly, tube 124B includes an electrical switch with electrical contact/pin 192 and female contact 194. Cylindrical structure 127B may include an outer insulator surrounding a sliding electrical contact that makes contact with contact 192 when the visible open switch is closed.

As illustrated, viewing window 144 allows personnel to see whether a ground connection is made and viewing window 154 allows personnel to see whether an electrical connection or a visible open is present in the electrical circuit. For example, the ground circuit in tube 124A is shown in the open position in which the electrical ground contact/pin 182 is not mated/connected to female contact 184, thereby showing an open area in the ground circuit that is viewable through viewing window 144. The electrical circuit in tube 124B is also shown in the open position, in which the electrical contact/pin 192 is not mated/connected to female contact 194. When the switch in tube 124A (or 124B) closes, the contacts for that switch close.

In some implementations, the area on the back side of tube 124B may be green in color to provide a further visual indication that the electrical circuit is open, as described in more detail below. In addition, tubes 124A and 124B may be filled with an insulating fluid. For example, in one implementation, the chambers labeled 129A and 129B are filled with silicone fluid or some other type of fluid or gel that acts as an insulator.

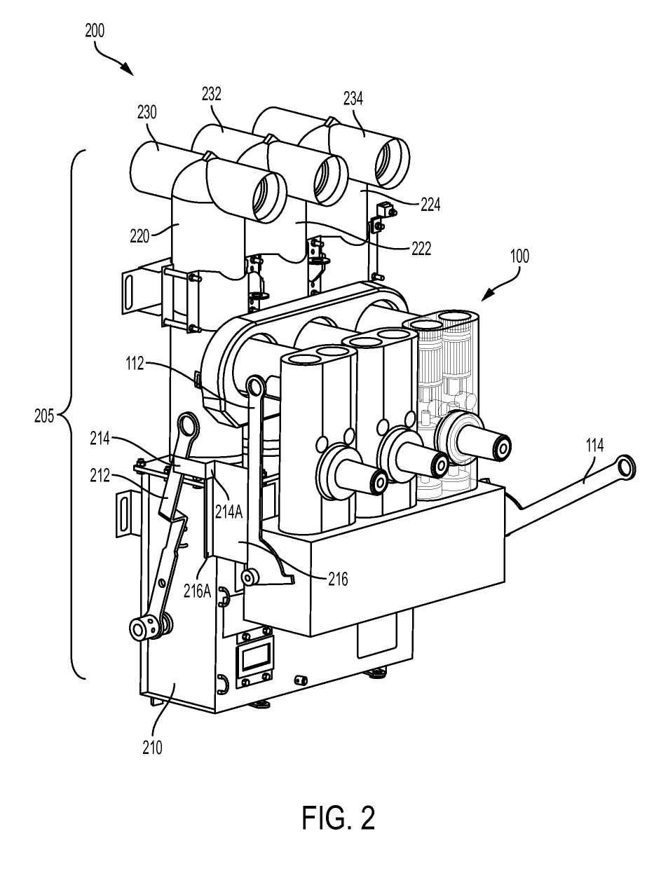

As discussed above, switchgear 100 may be connected to additional switchgear that provides power to switchgear 100. For example, FIG. 2 illustrates switchgear assembly 200 which includes switchgear 205 coupled to switchgear 100. Switchgear 205 is illustrated as being 3-phase switchgear that connects to 3-phase swithgear 100. In other implementations, switchgear 205 may be single phase switchgear, which would connect to a single phase switchgear 100. Referring to FIG. 2, switchgear 200 includes enclosure 210, operating handle 212, members or tubes 220, 222 and 224 and T-connectors 230, 232 and 234. Each of tubes 220, 222 and 224 may include a molded vacuum interrupter (MVI) or molded vacuum switch (MVS) (referred to collectively herein as molded vacuum circuit breakers). Operating handle 212 (also referred to herein as MVI operating handle 212) includes mechanisms that operate to trip the molded vacuum circuit breakers located in each of tubes 220, 222 and 224. For example, electrical power may be supplied to swithgear 205 via one side of two-way T-connectors 230, 232 and 234. MVI operating handle 212 may operate to trip the molded vacuum breakers located in each of tubes 220, 222 and 224 to disconnect the power provided to switchgear 205 via conductors coupled to switchgear 205 via terminals 230, 232 and 234. In some instances, electrical control equipment located in enclosure 210 may automatically trip the breakers based on the sensed conditions, such as the sensed current and/or voltage conditions associated with one or more of the electrical conductors connected to swithgear 205.

Switchgear 205 also includes interlocking mechanisms with switchgear 100 to ensure that the circuits connected to swithgear assembly 200 are not opened/closed out of sequence. For example, MVI operating handle 212 includes a mechanical interlock with visible open operating handle 112 to ensure that visible open operating handle 112 cannot open unless MVI operating handle 212 is in the open position.

In one implementation, the interlocking mechanism includes interlocking metal portions that extend from MVI operating handle 212 and visible open operating handle 112. For example, referring to FIG. 2, MVI operating handle 212 includes a metal portion 214 (referred to herein as interlock 214) welded/connected to the upper portion of MVI operating handle 212. Interlock 214 includes a planar portion that extends from MVI operating handle 212 and a portion labeled 214A that extends perpendicularly in an inward direction from the planar portion. The perpendicular portion 214A interlocks with plate 216 which is welded/connected to visible open operating handle 112, as illustrated in FIG. 2.

For example, visible open operating handle 112 includes a metal plate 216 (referred to as interlock 216) that is welded/connected to a lower portion of visible break operating handle 112. Interlock 216 includes a planar portion that extends from visible break operating handle 112 and a portion labeled 216A that extends perpendicularly in an outward direction from the planar portion. Portion 214A of interlock 214 overlaps or interlocks with portion 216A of interlock 216. As a result, visible open operating handle 112 cannot be pulled forward to move to the open position unless MVI operating handle 212 is in the open position. That is, interlocks 214 and 216 prevent visible open operating handle 112 from moving when MVI operating handle 212 is in the closed position illustrated in FIG. 2

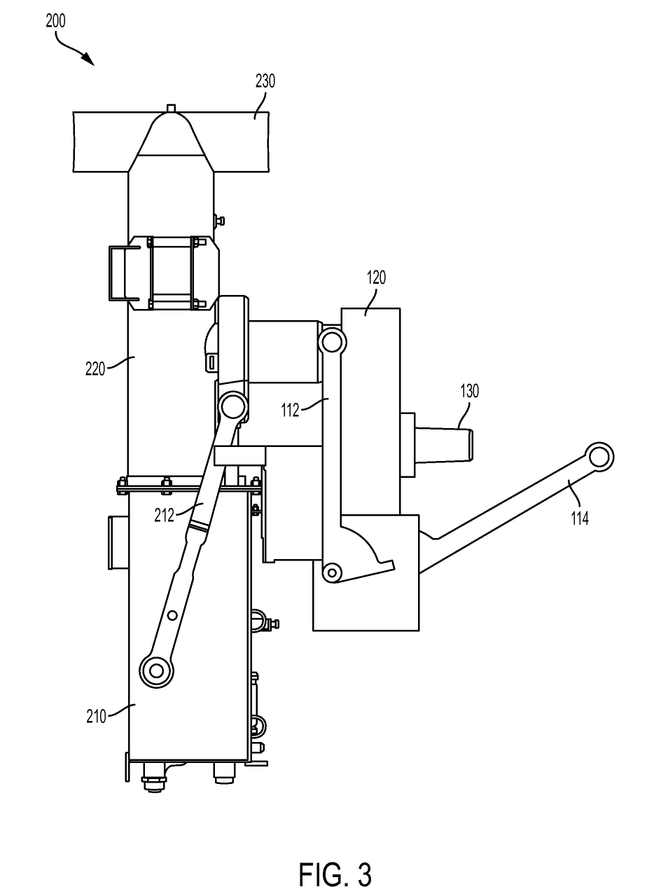

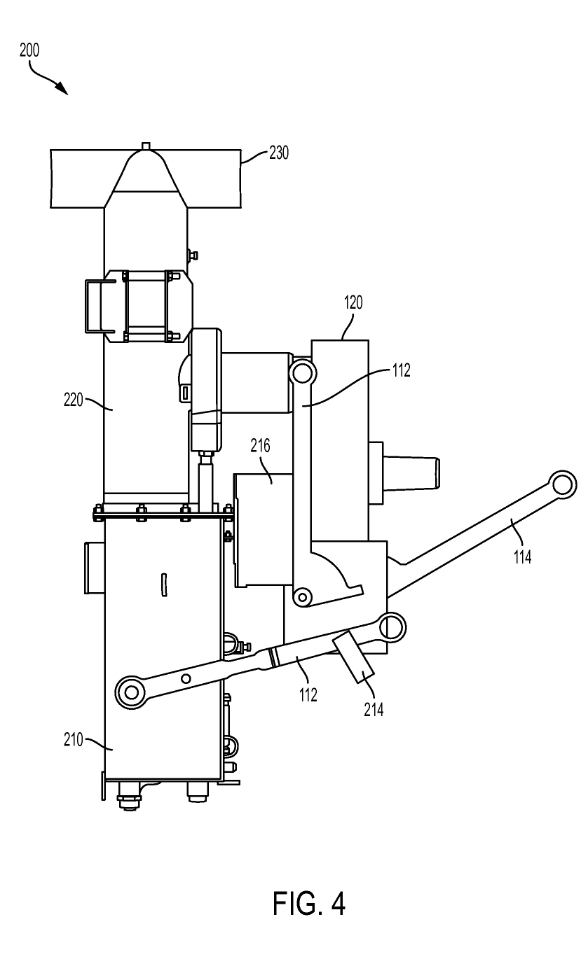

FIG. 3 illustrates a side view of switchgear assembly 200. In FIG. 3, MVI operating handle 212 is shown in the closed position, visible break operating handle 112 is shown in the closed position and ground operating handle 114 is shown in the open position (i.e., ungrounded). Assume that personnel would like to de-energize the electrical circuits coupled to switchgear assembly 200 to perform maintenance or other work on switchgear assembly 200. In this case, personnel may pull MVI operating handle 212 from the closed position illustrated in FIG. 3 to the open position illustrated in FIG. 4. Referring to FIG. 4, the operating personnel may move MVI operating handle 212 in the downward direction to trip the molded vacuum breakers included in tubes 220, 222 and 224. As illustrated, interlock 214 moves with MVI operating handle 212, thereby releasing the interlock with interlock 216 of visible open operating handle 112.

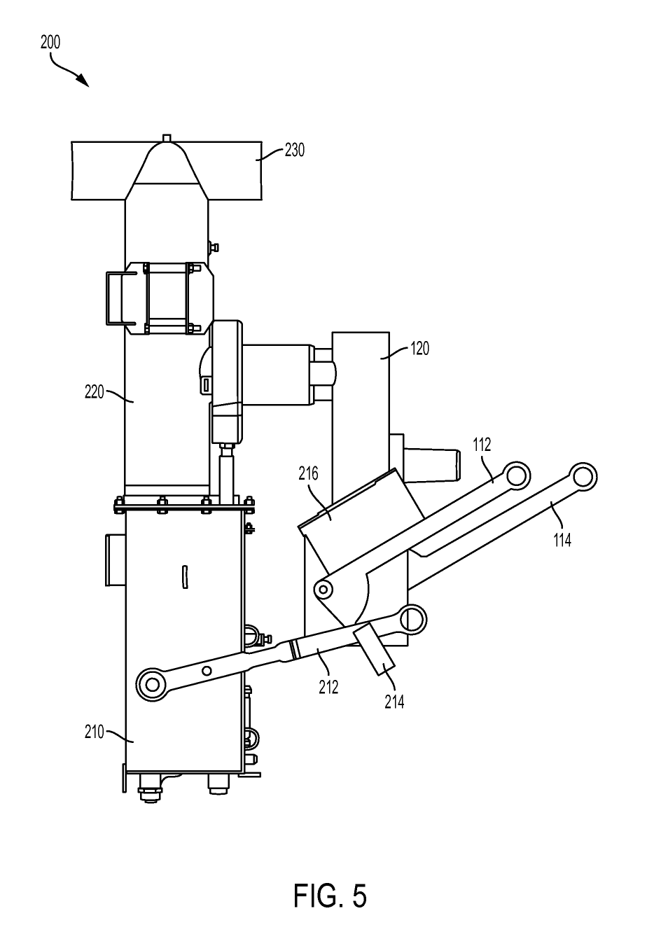

Next, personnel may open visible break operating handle 112, as illustrated in FIG. 5. For example, personnel may move visible break operating handle 112 in the downward direction to open the switches/breakers located in tubes 120, 122 and 124. As illustrated, interlock 216 moves with visible open operating handle 112 since interlock 216 is no longer interlocked with interlock 214. When the circuit breakers/switches are tripped, visible break contacts may be viewed to ensure that the circuits are de-energized.

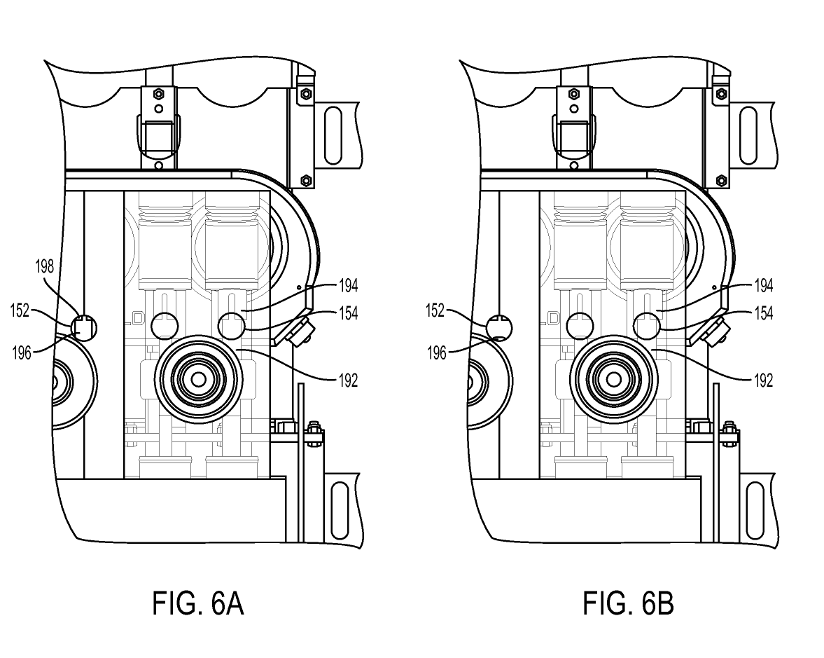

For example, FIG. 6A illustrates visible break open windows 152 and 154 associated with two phases of the switchgear 100 in the closed portion (e.g., energized). As illustrated, viewing window 154 illustrates electrical contact 192 coupled to female contact 194 and viewing window 152 illustrates electrical contact 196 coupled to female contact 198. Personnel may look at the contacts via viewing windows 152 and 154 and determine that switchgear 100 may not be de-energized. The third set of visible break contacts (not shown) will also be in the closed position. The closed position corresponds to visible break operating handle 112 being in the closed position.

FIG. 6B illustrates visible break contacts after visible break operating handle 112 has been moved to the open position illustrated in FIG. 5. Referring to FIG. 6B, after the circuit breakers have been tripped, electrical contacts 192 and 196 move in the downward direction (via an actuating rod, not shown) to open the circuit connection. Personnel can then look in viewing windows 152 and 154 and see that the contacts are open (e.g., the circuit is de-energized).

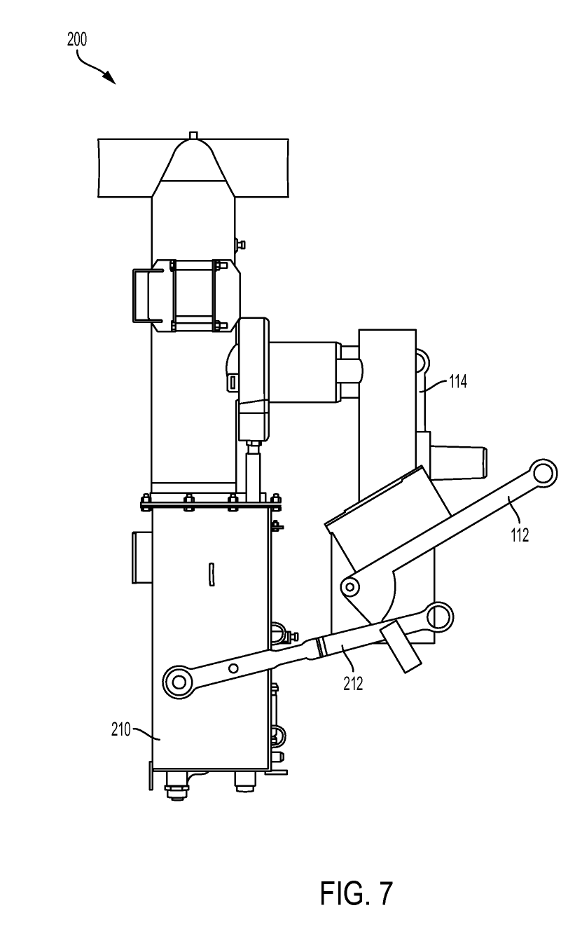

Next, personnel may close ground operating handle 114 by moving ground operating handle 114 in the upward direction, as illustrated in FIG. 7. In one implementation, ground operating handle 114 is linked to visible break operating handle 112 via a mechanical interlocking mechanism that prevents ground operating handle 114 from being closed when visible break operating handle 112 is not in the open position. For example, visible break operating handle 112 may be linked to ground operating handle 114 via mechanical link(s) located in cabinet 110. As one example, visible break operating handle 112 may include an interlocking portion that overlaps or meshes with a corresponding interlocking portion of ground operating handle 114. When visible open operating handle 112 is moved to the open position, the interlock is released/cleared and ground operating handle 114 may be closed.

Referring to FIG. 7, MVI operating handle 212 is in the open position, visible break operating handle 112 is in the open position and ground operating handle 114 is in the closed position. Visible ground operating handle 114 closes the ground contacts. The ground contacts may be connected to ground stud 160 (FIG. 1A), which is connected to a ground.

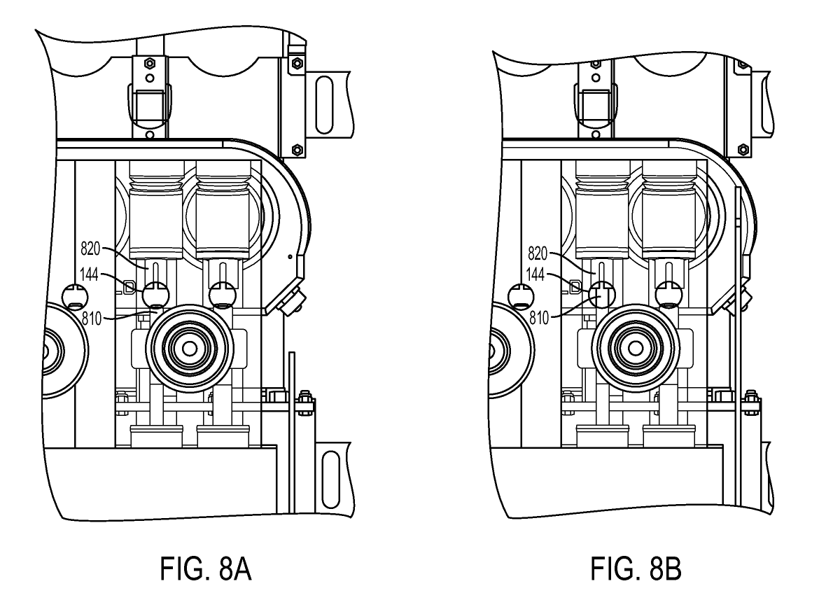

FIG. 8A illustrates viewing window 144 associated with one phase of the ground connection for switchgear 100 in the open position (e.g., ungrounded). By looking through viewing window 144, operating personnel may see an opening between ground pin/contact 810 and its corresponding female contact 820 and determine that switchgear 100 is not grounded. The other viewing windows associated with the ground connections (i.e., windows 140 and 142, not shown in FIG. 8A) will similarly show that the ground connections are open. The open position corresponds to visible ground operating handle 114 being in the open position. FIG. 8B illustrates the state of the ground contacts with ground operating handle 114 being in the closed position. As illustrated, ground contact 810 is coupled or connected to female contact 820. Personnel can look in viewing window 144 (and viewing windows 140 and 142) to see that the ground connections have been made.

In this manner, interlocks between switchgear 100 and switchgear 205 ensure that various breakers and/or switches cannot be operated out of sequence. In addition, viewing windows allow personnel to determine whether the circuits are de-energized before working on the equipment. To re-energize switchgear 200, personnel may perform the sequence of operations described above in reverse order.

For example, ground switch 114 may be moved from the closed position to the open position. Next, visible break operating handle 112 may be moved from the open position to the closed position. Lastly, MVI operating handle 212 may be moved from the open position to the closed position. Similar to the discussion above regarding de-energizing switchgear assembly 200, the mechanical interlocks between MVI operating handle 212 and visible open operating handle 112, and the mechanical interlocks between visible open operating handle 112 and ground operating handle 114 prevent personnel from performing the re-energizing process out of the proper sequence. For example, the mechanical interlock between ground operating handle 114 and visible break operating handle 112 prevents visible break operating handle 112 from being moved to the closed position when ground operating handle 114 is in the closed position. Similarly, interlocks 214 and 216 prevent MVI operating handle 212 from being moved to the closed position when visible open operating handle 112 is in the open position.

As described above, the visible break and visible ground circuit breakers/switches may be implemented in a 3-phase assembly, as illustrated in FIG. 1A and as described above. As also described above, implementations consistent with the description above may be used in a single phase assembly. That is, a visible break and visible ground may be implemented in a single phase installation.

In addition, in some implementations, switchgear 100 may include a visible break assembly, without including a visible ground assembly (or vice versa). In this implementation, each of tubes 120, 122 and 124 may include only a single tube that houses an electrical switch, as opposed to two individual tubes housing both an electrical switch and a ground switch. For example, in such an implementation, tube 124 will include only tube 124B which will allow personnel to view the state of the electrical switch (e.g., opened or closed). In addition, in this implementation, visible open operating handle 112 interlocks with MVI operating handle 212, but may not interlock with a ground operating handle, such as ground operating handle 114. For example, in some implementations, switchgear 100 may not include a ground operating handle.

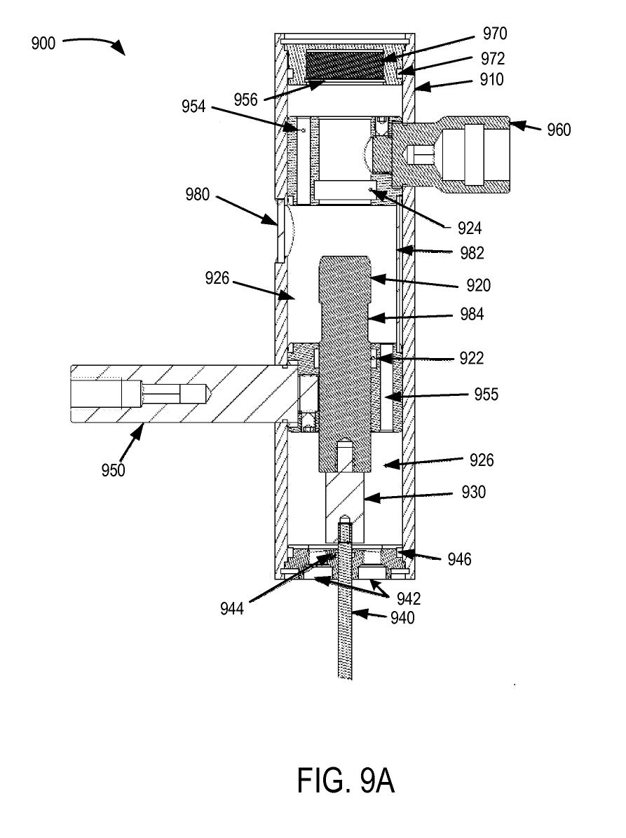

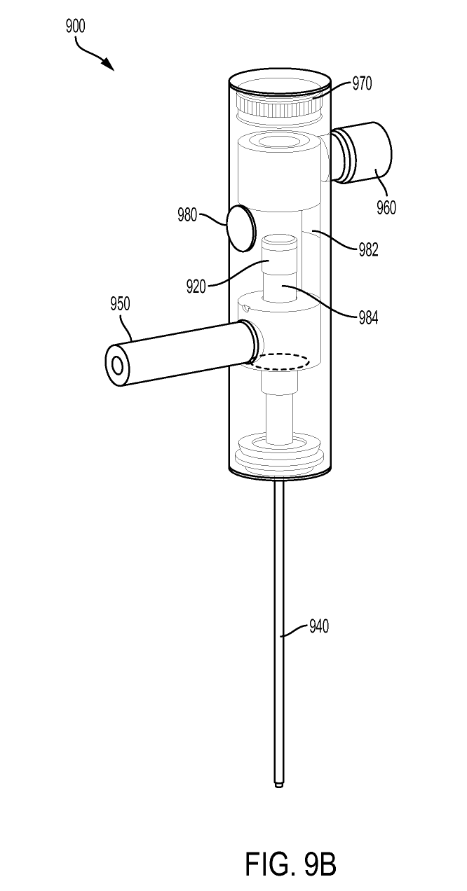

FIG. 9A illustrates a cross-sectional view of a visible open switch 900 that may be used in switchgear 100 in accordance with an exemplary implementation. For example, visible open switch 900 may correspond to one of the electrical switches included in tubes 120, 122 and 124. Referring to FIG. 9A, visible open switch 900 is a closed cell switch that includes an outer shell or tube 910, electrical contact 920, insulator 930, actuator rod 940, terminal 950, terminal 960, closed cell volume compensator 970 and viewing window 980.

Tube 910 may be made of overmolded insulating rubber and a conductive outer jacket. Tube 910 may also be surrounded by an insulating rubber (not shown), such as EPDM, that protects the components of visible open switch 900. Contact 920 may include a conductive contact or pin that moves within chamber 926 to make contact with female electrical contact 924 when switch 900 is closed.

Contact 920 may be coupled to actuator rod 940 via insulator or linking rod 930. Actuator rod 940 and switch 900 are shown in FIG. 9 in the open position. When switch 900 is closed, actuator rod 940 and contact 920 move within chamber 926 in the longitudinal direction and electrical contact 920 mates with female electrical contact 924, which then mates with a corresponding contact/lug located in terminal 960. Chambers 926 may be filled with fluid or gel, such as silicone fluid, that acts as an insulator. The lower portion of switch 900 includes fill/vent ports 942 used to fill chambers 926 with the insulating fluid, a sliding seal 944 and a static seal 946. Terminal 950 may correspond to one of bushings 130, 132 or 134 and include an electrical contact/conductor that is connected to an electrical load. When switch 900 is closed, the electrical contact/conductor supplies power to the connected load.

The upper portion of visible open switch 900 includes closed cell foam volume compensator 970 and static seal 972. The lower portion of closed cell foam volume compensator 970 abuts a metallic perforated plate 956. The upper portion of switch 900 also includes fluid passage 954 and the lower portion of switch 900 includes fluid passage 955 that allow fluid to be displaced when actuating rod 940 moves linking rod/insulator 930 and electrical contact 920 to close switch 900. For example, since switch 900 is housed in an enclosed cell/chamber, movement of electrical contact 920 causes displacement of the silicone fluid. Closed cell foam volume compensator 970 may be made of a compressible foam or other material that compresses when the silicon fluid is displaced by the closing of switch 900, thereby ensuring that the silicone fluid does not escape via the various seals and fill ports (e.g., seals 944 and 946 and ports 942). In other implementations, a diaphragm may be used in place of closed cell foam volume compensator 970 that functions to compress or move when fluid is displaced by the closing of switch 900.

Viewing window 980 may correspond to one of viewing windows 150, 152 or 154 (or viewing windows 140, 142 or 144) in FIG. 1A. In one implementation, the back portion of chamber 926, labeled 982 in FIG. 9A, may be green in color. For example, a green colored reflective tape or other green colored material may be placed at area 982. In this manner, when switch 900 is in the open position (as illustrated in FIG. 9A), personnel may look through viewing window 980 and see that the electrical connection is open, (as discussed above and illustrated in FIG. 6B), as well as see the color green. This may further enhance the ability to easily discern the open/closed status of switch 900.

In addition, in this implementation, a portion of contact 920 may include a band of reflective tape or a collar that is red in color at the area labeled 984 in FIG. 9A. In this case, when switch 900 is closed, the portion of contact 920 at area 984 is visible via viewing window 980. As a result, personnel may see that the switch contacts are closed, as well as see the color red, further indicating that switch 900 is closed.

In some implementations in which a ground switch is used, no color indicators may be used for the ground switch. That is, personnel may simply look in the appropriate viewing window to determine whether the ground connection is open or closed. Alternatively, in some implementations, color indicators may be used for the ground switch. In such implementations, the colors may be reversed. For example, when the ground switch is closed, a portion of the ground contact may be green in color to indicate that the ground switch is closed/grounded. When the ground switch is open, the back portion of the switch may be red in color to indicate that the ground switch is open/ungrounded.

FIG. 9B illustrates an isometric view of visible open switch 900 in the open position. As illustrated, when switch 900 is open, personnel may look through viewing window 980 and see that the contact has not been made. Personnel may also view the back side of chamber 910 at the area labeled 982 is green in color. When switch 900 is closed, electrical contact/pin 920 moves in the upward direction and the portion of pin 920 labeled 984 is located at an area parallel to viewing window 980. As a result, personnel may look through viewing window and see that the contacts are closed and also see the color red, further indicating that the contacts are closed.

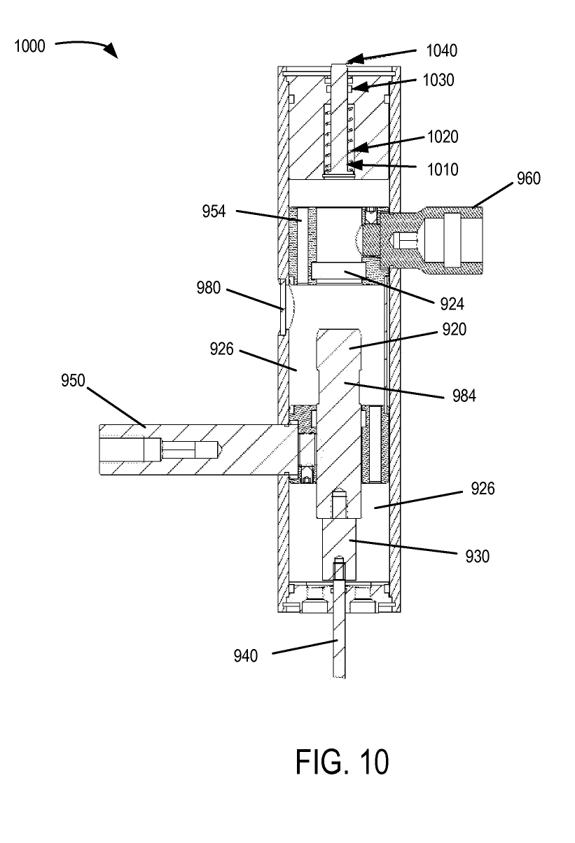

FIG. 10 illustrates a cross-sectional view of another visible open switch that may be used in switchgear 100 in accordance with another exemplary implementation. Referring to FIG. 10, visible open switch 1000 is similar visible open switch 900, but uses a piston mechanism, as opposed to the closed cell foam compensator 970 to adjust for movement of actuating rod and electrical contact within the closed cell switch 900. For example, visible open switch 1000 includes a piston 1010 and a return spring 1020 that adjust and compensate for movement of electrical pin/contact 920 and the displacement of the silicone fluid. For example, movement of the silicone fluid may cause movement of piston 1010. Visible open switch 1000 also includes sliding seal 1030 and switch position indicator 1040 that slides upward when switch 1000 is closed, caused by movement of piston 1110. Position indicator 1040 may display “Closed” when switch 1000 is closed, thereby providing a further indication as to the status of visible open switch 1000. When switch 1000 is opened, piston 1110 moves back down and the status indicator 1040 displays an open indication.

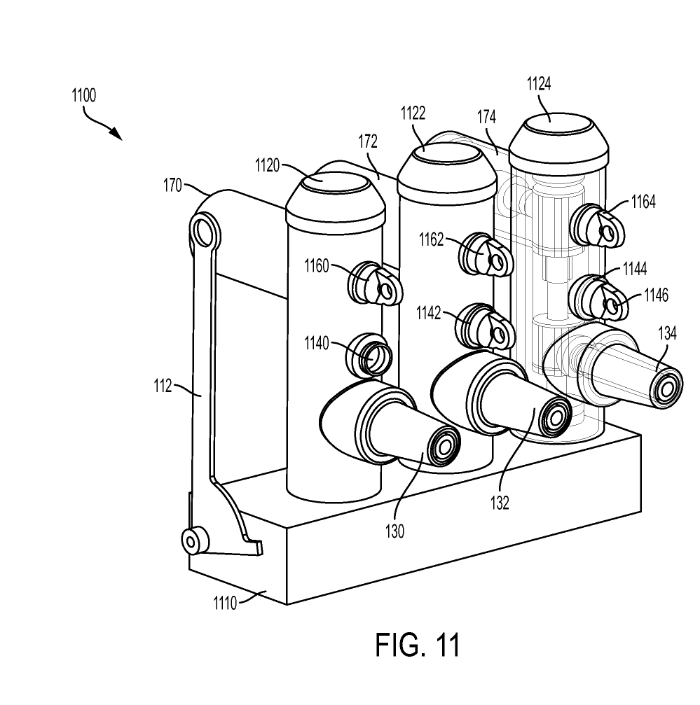

As described above, in some implementations, switchgear similar to switchgear 100 may include a visible break assembly, without including a visible ground assembly (or vice versa). For example, FIG. 11 illustrates switchgear 1100 that includes a visible break assembly, but does not include a visible ground assembly. Referring to FIG. 11, switchgear 1100 includes enclosure or cabinet 1110, visible break operating handle 112, tubes or bodies 1120, 1122 and 1124, interfaces/bushings 130, 132 and 134, viewing windows 1140, 1142 and 1144 and interfaces/terminals 170, 172 and 174. Interfaces/bushings 130, 132 and 134 and interfaces/terminals 170, 172 and 174 may be similar to interfaces/bushings 130-134 and interfaces/terminals 170-174, respectively, described above with respect to switchgear 100. The exemplary configuration illustrated in FIG. 11 is provided for simplicity. It should be understood that switchgear 1100 may include more or fewer devices than illustrated in FIG. 11.

Each of tubes 1120, 1122 and 1124 may be similar to tubes 120, 122 and 124 illustrated in FIG. 1A, but may house an electrical switch, as opposed to an electrical switch and a ground switch. For example, each of tubes 1120, 1122 and 1124 may include an outer shell made of an insulating material, such EPDM or some other type of rubber, and may include an electrical switch associated with one phase of switchgear that may be coupled to switchgear 205 (FIG. 2).

Each of tubes 1120, 1122 and 1124 includes one viewing window associated with its corresponding electrical switch. For example, tube 1120 includes viewing window 1140, tube 1122 includes viewing window 1142 and tube 1124 includes viewing window 1144. Each of windows 1140, 1142 and 1144 may be circular or oval shaped and be made of a transparent plastic, glass or other transparent material that allows personnel to see inside the corresponding tube. When visible break operating handle 112 is moved from the closed position illustrated in FIG. 11 to the open position, the electrical circuit breakers/switches in each of tubes 1120, 1122 and 1124 are opened, in a similar manner as discussed above with respect to switchgear 100. Personnel may then look into viewing windows 1140, 1142 and 1144 and verify that the electrical connections are open, in a similar manner as described above with respect to switchgear 100 and switches 900 and 1000. In addition, visible break operating handle 112 may include an interlock (not shown in FIG. 11) that interlocks with MVI operating handle 212 in a similar manner as described above with respect to FIGS. 2-4 to prevent out of sequence operation.

Viewing windows 1142 and 1144 are illustrated in FIG. 11 as including plugs, such as plug 1146 inserted in viewing window 1144. The plugs may be removed at the time of installation of switchgear 1100 or left in place. If the plugs are left in place after installation, personnel may remove the plugs (e.g., plug 1146) to view the status of the corresponding electrical switch.

Each of tubes 1120, 1122 and 1124 may also include voltage detection points 1160, 1162 and 1164, as illustrated in FIG. 11. The voltage detection points may be used by personnel to measure voltage of the conductors in each of tubes 1120, 1122 and 1124 to further determine whether a circuit is energized.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, implementations described herein have been described with respect to use of switchgear in either a three phase or single phase implementation. In either case, implementations described herein may be used with low, medium or high voltage equipment, such as switchgear that is used with 15 kilovolt (kV), 25 kV, 35 kV or higher (or lower) voltages.

In addition, embodiments described above refer to using various operating handles (e.g., MVI operating handle 212, visible break operating handle 112 and ground operating handle 114) to control various operations. In other implementations, other types of mechanical mechanisms may be used to ensure that various breakers and/or switches cannot be operated out of sequence. For example, the mechanical interlocks may not be included on or attached to the operating handles themselves. As one example, switchgear 205 (or switchgear 100) may include a pin that can only be pulled when MVI operating handle 212 is in the open position. The pin may also be coupled to visible break operating handle 112 to prevent visible break operating handle 112 from being moved to the open position when the pin has not been pulled. Similar pin interlock(s) may be used between visible break operating handle 112 and ground operating handle 114 to prevent operation of various switches and/or ground connections that is not in accordance with the desired sequence of operations. It should be understood that other types of mechanical interlocks and/or controls may be used to prevent out of sequence operation. In each case, personnel may also view the status of the various switches and connections via one or more viewing windows.

Further, embodiments described above refer to using mechanical type interlocks to control various operations. In other implementations, the various switches/breakers may be motor operated and may be opened and closed via control buttons located on switchgear assembly 200 or located remotely from switchgear assembly 200. For example, instead of manually moving MVI operating handle 212 from the closed position to the open position, personnel may press a button on switchgear 205. Similarly, personnel may press a button on switchgear 100 to open and close visible break switches and ground switches. In this case, the mechanical interlocks described above for MVI operating handle 212, visible break operating handle 112 and ground operating handle 114 may be replaced with electrical interlocks and/or controls that prevent operations that do not correspond to the proper operating sequence. In each case, personnel may verify the state of the switches via the viewing windows.

In addition, switchgear 100 is illustrated as including switches 900 or 1000 (FIGS. 9A and 10). It should be understood that switchgear 100 (or switchgear 205) may include any type of electrical switch and/or ground switch with any type of contact mechanism.

Further, implementations described herein refer to use of switchgear assembly 100 connecting/interface with switchgear assembly 205. In some implementations, switchgear 100 may be used in situations in which switchgear 205 is already installed. In such situations, switchgear 100 may be provided without requiring any or significant changes to existing switchgear 205.

Still further, implementations described above include use of visible open switches, such as switches 900 or 1000 that include a male contact that moves in a longitudinal direction within a chamber to make contact with a female contact. In other implementations, a “flag” type contact may be used to close, open and/or ground a circuit. For example, a rotating flag/electrical contact may be coupled to a rotating shaft. In one implementation, one side of the rotating flag is red in color, an edge portion of the flag is green in color, and the other side of the rotating flag is yellow in color. When a visible break operating handle is moved to a closed position, the rotating shaft may rotate the flag/electrical contact to close the switch/circuit breaker. In this case, the red side of the rotating flag may be visible through the viewing window, indicating that the circuit is closed. When the visible break operating handle is moved to the open position to open the switch, the rotating shaft rotates the flag approximately 90 degrees so that the edge portion of the flag is visible. In this case, the green edge of the rotating flag will be visible through the viewing window, indicating that the circuit is open. When the ground handle is moved to the grounded/closed position, the rotating shaft rotates the flag another 90 degrees to ground the circuit. In this case, the yellow side of the rotating flag may be visible through the viewing window, indicating that the circuit is grounded. In this manner, three switch positions (i.e., closed, open and grounded) may be visible to personnel via a rotating flag type contact.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A switchgear assembly, comprising:
a first body housing at least one vacuum circuit breaker;
a first control enclosure connected to the first body, the first control enclosure comprising a first operating handle configured to open and close the at least one vacuum circuit breaker;
a second body coupled to the first body via an interface connection, wherein the second body includes at least one viewing window and houses at least one switch; and
a second control enclosure connected to the second body, the second control enclosure comprising a second operating handle, wherein the second operating handle is interlocked with the first operating handle to prevent the at least one switch from being opened when the at least one vacuum circuit breaker is closed,
wherein the at least one viewing window is configured to display an open connection for the at least one switch when the second operating handle is in the open position and display a closed connection for the at least one switch when the second operating handle is in the closed position.

2. The switchgear assembly of claim 1, wherein the second operating handle is mechanically interlocked with the first operating handle to prevent the second operating handle from being moved to an open position when the first operating handle is in a closed position.

3. The switchgear assembly of claim 2, wherein the first operating handle includes a first portion that extends from the first operating handle and a second portion that extends in a perpendicular direction from the first portion,
wherein the second operating handle includes a plate that extends from the second operating handle and a third portion that extends in a perpendicular direction from the plate, and
wherein the second portion of the first operating handle overlaps with the third portion of the second operating handle to form a mechanical interlock when the first operating handle and the second operating handle are each in the closed position.

4. The switchgear assembly of claim 2, wherein the second control enclosure comprises a third operating handle and the at least one switch comprises a first switch and a second switch, the first switch coupled to an electrical circuit and the second switch coupled to a ground circuit, wherein the second operating handle is configured to open and close the first switch and the third operating handle is configured to open and close the second switch.

5. The switchgear assembly of claim 4, wherein the second switch is mechanically interlocked with the third switch to prevent the third operating handle from being moved to a closed position when the second operating handle is in the closed position.

6. The switchgear assembly of claim 1, wherein the second body comprises a first housing and a second housing,
wherein the first housing includes a first viewing window and a first switch, the first switch being configured to open and close contacts for an electrical circuit coupled to the second body, and
wherein the second housing includes a second viewing window and a second switch, the second switch being configured to open and close contacts for a ground circuit.

7. The switchgear assembly of claim 1, wherein a first portion of a back side of an interior of the second body is green in color, wherein when the at least one switch is open, the first portion is visible through the at least one viewing window.

8. The switchgear assembly of claim 7, wherein an electrical conductor included in the second body includes a band or collar that is red in color, wherein when the at least one switch is closed, the red band or collar is visible through the at least one viewing window.

9. The switchgear assembly of claim 1, wherein the first body comprises three phase switchgear and the at least one vacuum circuit breaker comprise first, second and third vacuum circuit breakers, and
wherein the second body comprises three phase switchgear and the at least one switch comprises first, second and third switches.

10. The switchgear assembly of claim 1, wherein the at least one switch comprises a closed cell switch filled with insulating fluid or gel, the closed cell switch including a foam portion configured to compress when the closed switch closes caused by displacement of the insulating fluid or gel during operation of the closed cell switch.

11. The switchgear assembly of claim 1, wherein the at least one switch includes an insulating fluid or gel and a piston mechanism that is configured to move in response to displacement of the insulating fluid or gel during operation of the switch.

12. The switchgear assembly of claim 11, wherein an upper portion of the piston mechanism includes a switch position indicator, and wherein when the at least one switch is in a closed position, the switch position indicator is visible and provides a closed indication.

13. An assembly, comprising:
a first member housing an electrical switch, the first member including a first viewing window through which contacts of the electrical switch are viewable; and
a first control enclosure connected to the first member, the first control enclosure comprising a first operating handle, wherein the first operating handle is interlocked with a second operating handle for a vacuum circuit breaker coupled to the assembly, wherein the second operating handle prevents the first operating handle from opening the electrical switch when the second operating handle is in a closed position, and
wherein the first viewing window is configured to display an open connection for the electrical switch when the first operating handle is in the open position and display a closed connection for the electrical switch when the first operating handle is in the closed position.

14. The assembly of claim 13, wherein the first operating handle includes a plate that extends from the first operating handle and a first portion that extends perpendicularly from the plate, and wherein the second operating handle includes a second portion that extends from the second operating handle and a third portion that extends perpendicularly from the second portion, and
wherein the first portion of the first operating handle overlaps with the third portion of the second operating handle to form a mechanical interlock when the first operating handle and the second operating handle are each in the closed position.

15. The assembly of claim 13, further comprising:
a second member housing a ground switch, the second member including a second viewing window through which ground contacts for the ground switch are viewable,
wherein the first control enclosure comprises a third operating handle, wherein the third operating handle is configured to open and close the ground switch.

16. The assembly of claim 15, wherein the first operating handle is mechanically interlocked with the third operating handle to prevent the third operating handle from being moved to a closed position when the first operating handle is in the closed position.

17. The assembly of claim 13, wherein a first portion of a back side of an interior of the first member is green in color, wherein when the electrical switch is open, the first portion is viewable through the first viewing window.

18. The assembly of claim 17, wherein an electrical contact for the electrical switch includes a band or collar that is red in color, wherein when the electrical switch is closed, the collar is viewable through the first viewing window.

19. The assembly of claim 13, further comprising:
a second member housing a second electrical switch with a second viewing window through which contacts of the second electrical switch are viewable; and
a third member housing a third electrical switch with a third viewing window through which contacts of the third electrical switch are viewable,
wherein the first operating handle is configured to open and close the electrical switch, the second electrical switch and the third electrical switch.

20. The assembly of claim 13, wherein the electrical switch is filled with insulating fluid or gel and includes a compressible foam portion, wherein the compressible foam portion is configured to compress when the electrical switch closes caused by displacement of the insulating fluid or gel during operation of the electrical switch.

21. The assembly of claim 13, wherein the electrical switch is filled with insulating fluid or gel and includes a piston that is configured to move in response to displacement of the insulating fluid or gel during operation of the electrical switch.

22. The assembly of claim 21, wherein an upper portion of the piston includes a switch position indicator, and wherein when the electrical switch is in a closed position, the switch position indicator is visible and provides a closed indication.

23. A three phase switchgear assembly, comprising:
first switchgear comprising first, second and third circuit breakers;
a first control enclosure connected to the first switchgear, the first control enclosure comprising a first operating handle configured to open and close the first, second and third circuit breakers;
second switchgear comprising first, second and third switches coupled to the first switchgear via interface connections, wherein the second switchgear includes first, second and third viewing windows; and
a second control enclosure connected to the second switchgear, the second control enclosure comprising a second operating handle, wherein the second operating handle is interlocked with the first operating handle to prevent the first, second and third switches from being opened when the first, second and third circuit breakers are closed,
wherein the first, second and third viewing windows are each configured to display an open connection when the second operating handle is in the open position and display a closed connection when the second operating handle is in the closed position.

24. The three phase switchgear assembly of claim 23, wherein the second switchgear further comprises fourth, fifth and sixth switches connected to a ground and the second switchgear includes fourth, fifth and sixth viewing windows through which ground contacts for the ground switches are viewable.
